(19) United States
(12) Patent Application Publication
(10) Pub. No.: US 2006/0238122 A1
(43) Pub. Date: Oct. 26, 2006

(54) Plasma display panel

(76) Inventor: Morio Fujitani, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/550,915

(22) PCT Filed: Feb. 8, 2005
(86) PCT No.: PCT/JP05/02186

§ 371 Date: Sep. 28, 2005

(30) Foreign Application Priority Data
Feb. 9, 2004 (JP) 2004-031781

(51) Int. Cl. H01J 17/49

(52) U.S. Cl. 313/582

(57) ABSTRACT

To reduce hydrocarbons existing inside the inner space of a PDP to thereby realize a PDP providing a high-quality picture and having a long life.

A catalyst reacting with hydrocarbons is provided on protective layer (8) formed on front panel (1) and barrier ribs (12), phosphor layers (13), and base dielectric layer (11) formed on back panel (2), in an exposed manner to the inner space of the PDP, so that the hydrocarbons are oxidized or decomposed by the catalytic activity of the catalyst with the hydrocarbons.

### TECHNICAL FIELD

The present invention relates to a plasma display panel known as a display device.

### BACKGROUND ART

Expectations for big-screen wall-hung televisions as interactive information terminals have recently been growing. Accordingly, there are various types of display panels used for that application. Among them, plasma display panels hereinafter referred to as “PDP”) are being paid great attention as flat type display devices excellent in visibility because of their being of a self emitting type making it possible to generate a beautiful image and to provide a big screen with ease. Therefore, development of them of higher definition and bigger screen is being advanced.

The PDP is classified into an AC and a DC type according to its driving method and divided into a surface discharge type and a facing discharge type according to its type of discharging. In view of its capability of providing higher definition and bigger screen and its ease of production, the surface discharge AC type PDP is prevailing now.

A PDP has a front panel with such component parts as electrodes, a dielectric layer, and a protective layer made of MgO formed thereon and a back panel with such component parts as barrier ribs and phosphor layers formed thereon, such that the panels are disposed to oppose each other with a minute space (inner space) formed in between. Their peripheries are sealed together ATTACHMENT B with a sealing member and the inner space is filled with a discharge gas of a mixture of neon and xenon at a pressure of around 665000 Pa (approximately 500 Torr). Such a structure is disclosed for example in a non-patent publication, H. Uchiike and S. Mikoshiba: “All About Plasma Display”, Kogyo Chosakai Publishing, Inc., pp. 79-80 (1997.05).

In order to prepare such component parts of a PDP, an inorganic material becoming the precursor, together with an organic binder and an organic solvent, are turned into a paste and the paste is applied to the panels and then dried and baked so that the material is solidified while the organic solvent and the organic binder are burned off. During such a baking process, various gases are generated and part of the gasses attach to the surface of the component parts as impurities. As a result, the attached impurities become a generating source of impurity gases within the inner space of the PDP, whereby such problems have occurred that the discharging in the PDP is adversely affected and the image quality and longevity thereof are deteriorated.

### DISCLOSURE OF INVENTION

In order to solve the above mentioned problems, the PDP of the present invention has a front panel and a back panel disposed to oppose each other with an inner space formed therebetween and a catalyst reacting with a hydrocarbon provided in an exposed manner to the inner space.

By virtue of such a configuration, hydrocarbons as impurities present in the inner space of a PDP as attached to surfaces of the component parts of the PDP can be reduced and a PDP with improved picture quality and prolonged life can be provided.

### BRIEF DESCRIPTION OF THE DRAWINGS

FIG. 1 is a sectional view in perspective illustrating a general configuration of a PDP according to an embodiment of the present invention.

FIG. 2 is a plan view illustrating a general structure of an image displaying section of the PDP in the embodiment of the present invention.

### DETAILED DESCRIPTION OF THE PREFERRED EBODIMENTS

A PDP of an embodiment of the present invention will be described below with reference to the accompanying drawings.

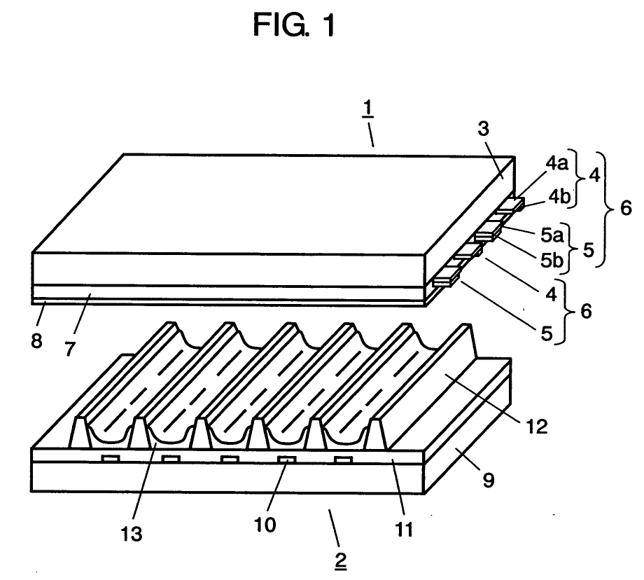

FIG. 1 is a sectional view in perspective illustrating a general configuration of a PDP of a preferred embodiment of the present invention. As illustrated in FIG. 1, the PDP is formed of front panel 1 and back panel 2.

Front panel 1 has transparent front substrate 3 formed of a glass substrate of borosilicate sodium glass made by a float process, on which are disposed, as component parts of the PDP, a plurality of stripe-patterned display electrodes 6, each thereof being formed of a pair of scanning electrode 4 and sustaining electrode 5, dielectric layer 7 covering display electrodes 6, and protective layer 8 made of MgO or the like formed over dielectric layer 7. Scan electrode 4 and sustaining electrode 5 are formed of their respective transparent electrodes 4a, 5a and bus electrodes 4b, 5b, formed of Cr/Cu/Cr or Ag and electrically connected with transparent electrodes 4a, 5a.

Back panel 2 has back substrate 9 arranged opposite to front substrate 3, on which are disposed, as component parts of the PDP, address electrodes 10 formed at right angles to display electrodes 6, base dielectric layer 11 covering address electrodes 10, stripe-patterned barrier ribs 12 placed on base dielectric layer 11, and phosphor layers 13 provided between each of barrier ribs 12 to cover the side face thereof and the surface of base dielectric layer 11. The pattern of barrier ribs 12 is not limited to the stripe pattern but it may have such patterns as a box type pattern or a meandering pattern. For providing color display, phosphor layers 13 have a red phosphor layer, a green phosphor layer, and a blue phosphor layer arranged in repeating sequence.

Front panel 1 and back panel 2 are arranged such that display electrodes 6 disposed on front panel 1 and address electrodes 10 disposed on back panel 2 are at right angles to each other and both the panels oppose each other across barrier ribs 12 so that a minute space is formed in between. Opposed front panel 1 and back panel 2 are sealed together at their peripheries with a sealing member and, inside the inner space, there is filled a mixed gas of neon and xenon, as a discharge gas, at a pressure of approximately 66500 Pa (500 Torr). Thus, a PDP is constructed. Although, FIG. 1 illustrates front panel 1 and back panel 2 as separated from each other to facilitate understanding of the inner structure, they are arranged to oppose each other with protective layer 8 over front panel 1 and the tops of barrier ribs 12 on back panel 2 held in contact.

Discharging occurs when periodic voltages are applied to address electrodes 10 and display electrodes 6 of the PDP configured as described above. Ultraviolet rays generated by the discharge are thrown on phosphor layers 13 and converted into visible rays, which make a display of a picture image.

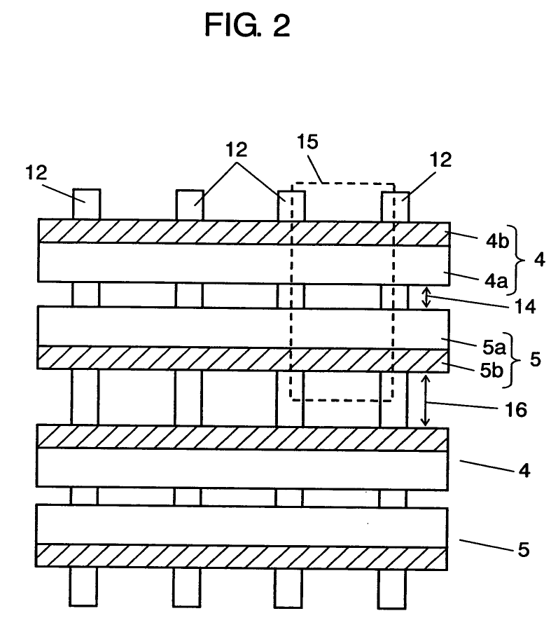

FIG. 2 is a plan view showing a general configuration of an image displaying section of the PDP according to the embodiment of the present invention. Scanning electrode 4 and sustaining electrode 5 formed on front panel 1 are alternately arranged so as to adjoin each other across discharge gap 14. A section of the inner space of the PDP partitioned by barrier ribs 12 and having therein an intersection of display electrode 6 and address electrode 10 at right angles functions as discharge cell 15 as a unitary light-emitting region. Sometimes, black stripes (not shown) are provided in non-illuminating regions 16 to improve contrast.

In the PDP according to the embodiment of the present invention, an inner space is formed between front panel 1 and back panel 2 opposed to each other and a catalyst reacting with a hydrocarbon is provided in an exposed manner to the inner space. More specifically, the catalysts reacting with a hydrocarbon are provided at regions exposed to the inner space of protective layer 8 formed on front panel 1 and phosphor layers 13, barrier ribs 12, and base dielectric layer 11 formed on back panel 2.

When impurity gases other than the discharge gas were present within discharge cells 15 of a PDP, variations in the discharging characteristic, such as variations in the discharge starting voltage of individual discharge cells 15, were caused and sometimes such a problem arouse as to deteriorate the picture quality of the displayed image. Also, there was such a problem that the presence of these impurity gases within the inner space of a PDP caused deterioration in the characteristics of phosphor layers 13, in particular, and deterioration in the characteristics of protective layer 8, thereby shortening the life of the PDP.

As a method for eliminating such impurity gases, it is generally practiced to subject a PDP to baking and evacuation during the process of production. More specifically, a PDP gone through the sealing process is heated so that impurities attached to the component parts within the inner space are separated and gasified and the PDP, in this condition, is subjected to vacuum evacuation, i.e., a method of the so-called evacuation baking is practiced. The evacuation baking, however, has involved such a problem that all of the regions within the inner space cannot be uniformly vacuum-evacuated for the reasons as stated below.

As a result of analysis of the inner space of a PDP undergone evacuation baking, it has been found that there remain hydrocarbons (CH) in the interior of the PDP gone through the evacuation baking, and existence of such hydrocarbons is the cause of deterioration of the picture quality. As the reasons for the hydrocarbons to remain even after the evacuation baking, the following factors can be considered. Namely, it seems that in many cases hydrocarbons (CH) become attached to the interior surfaces of the PDP via carbon's dangling bond (a bond missing a neighbor to which it is able to bind). Since the bond energy due to the dangling bond is quite high, breaking the bonds and releasing the hydrocarbons requires heating them up to a high temperature. However, the heating temperature in the conventional evacuation baking cannot be raised to a sufficiently high temperature by the limitation due to the softening point or melting point of the component parts composing the PDP. Therefore, it has been impossible to have such hydrocarbons fully separated from the component parts and exhausted off the PDP.

Even if the hydrocarbons are not that attached to the PDP via dangling bonds, it has been impossible to thoroughly exhaust the hydrocarbons off the PDP, especially when the hydrocarbons are such that have large molecular weight, because the exhaustion resistance in the evacuation is high due to the fact that the inner space of the PDP is very minute and the evacuation baking is performed through exhaustion holes and tubes provided in back substrate 9.

According to the PDP of the embodiment of the present invention, a catalyst reacting with hydrocarbons is provided in an exposed manner to the inner space of the PDP so that hydrocarbons are oxidized (burned) or decomposed by the catalytic action of the catalyst on hydrocarbons, whereby it is achieved to reduce the quantity of hydrocarbons existing in the inner space of the PDP.

Since the catalyst is provided in an exposed manner to the inner space of the PDP, it effectively acts with hydrocarbons existing as gasified in the inner space of the PDP. Even if hydrocarbons are such that are not gasified but are present within the PDP as attached to such places as the surfaces of the component parts of the PDP, oxidation or decomposition of the hydrocarbons is proceeded because there is present the catalyst and thus the quantity of the hydrocarbons can be reduced. In other words, the PDP is not required to be heated to such a high temperature as to gasify the hydrocarbons; nevertheless, the hydrocarbons can be reduced effectively.

Most organic substances inclusive of hydrocarbons undergo accelerated oxidative (burning) reaction or decomposing reaction in the presence of a catalyst and such a reaction is developed even when the catalyst is very small in amount. Further, since the catalyst itself does not suffer any change by the reaction, hydrocarbons existing in the inner space of the PDP can be effectively reduced.

A catalytic material suitable as a catalyst to accelerate oxidization of a hydrocarbon can be selected according to the order of combustion reactivity. When, for example, the hydrocarbon desired to be reduced is methane (CH₄), since the order of combustion reactivity with methane is given as Pd>Pt>Rh>Co₃O₄>PdO>Cr₂O₃>Mn₂O₃>CoO>NiO, these materials can be used as the catalyst and use of Pd or Pt is preferred. When, for example, propylene (CH₃CH═CH₂) is desired to be reduced, since the order of combustion reactivity with propylene is given as Pt>Pd>Rh>Ag₂O>Co₃O₄>CuO>MnO₂>CoO>NiO, Ag₂O or CuO can be used, in addition to those catalytic materials used for methane.

In the embodiment of the present invention, the catalyst is provided, for example, as contained in the component parts of the PDP such as protective layer 8, phosphor layers 13, barrier ribs 12, and base dielectric layer 11 that are exposed to the inner space of the PDP. Accordingly, in addition to the effect that hydrocarbons existing in the PDP after it has been completed as a PDP product can be reduced, such an effect is obtained that organic substances contained in the organic binder and the like of the paste can be completely burned up by virtue of the catalytic activity during the process of production of the PDP, especially in the baking process, whereby residual organic substances otherwise becoming impurities can be reduced. Also from this point of view, hydrocarbons existing in the PDP can be reduced.

As the condition in which the catalyst is present in an exposed manner to the inner space of the PDP, such a condition can be considered, for example, that the catalyst is present on the surfaces of protective layer 8, phosphor layers 13, and barrier ribs 12. However, even if the catalyst is provided inside phosphor layers 13, since phosphor layer 13 is a porous film formed of phosphor material particles, if viewed microscopically, is exposed to the inner space, hence such a portion should also be taken into consideration. Likewise, base dielectric layer 11 is exposed to the inner space via porous phosphor layers 13.

Decomposition of hydrocarbons by the action of a catalyst is considered to be proceeded in the following manner. Hydrocarbons frequently become high polymers and it is known that some kinds of them are decomposed when exposed to heat, light, radiation, and the like. Decomposition of a polymeric main chain such as a resin component includes a reaction called the depolymerization which can be regarded as a process reversal to the polymerization reaction. For example, polymethyl methacrylate used for a transfer film can be easily decomposed into a monomer by depolymerizing it at its transition temperature of 220° C. The term “transition temperature” here is defined as the temperature at which the speed of the growth reaction and that of the depolymerization reaction are equal. Namely, a catalyst starting polymerization also acts as a catalyst accelerating decomposition. The catalytic substances accelerating polymerization include Co, Mn, Zn, Ti, and Ni. Particular, Co, Mn, Zn, and Ti are mainly used for polycondensation, whereas Co, Ti, and Ni are used for addition polymerization. By addition of such substances, decomposition of hydrocarbons can be accelerated at lower temperatures.

Further, since TiO₂ has the ability to absorb ultraviolet rays to thereby decompose hydrocarbons, decomposition can be accelerated by throwing light thereon in the evacuation process. Further, since ultraviolet rays are generated by the discharge itself taking place in the PDP, TiO₂ can decompose hydrocarbons acting as a photocatalyst during the discharging. Therefore, even after a PDP has been sealed up and completed, it can be prevented from being adversely affected by hydrocarbons.

The amount of the catalytic substances added to the component parts is preferred to be as small as possible. Meanwhile, a catalyst exercises its catalytic activity even if its amount is very small and the catalyst itself suffers no such change as a change in its composition. Therefore, the amount of the catalytic substances may favorably be set to less than 20%, more favorably be set to less than 1%, or most favorably be set to 0.1% of the specific surface or the surface area of the component parts. As the method for providing catalytic substances on the component parts, such methods may be used as to spray them onto the component parts with use of a spray or the like or to mix them in the paste as the precursor for forming the component parts.

Incidentally, there is provided a tip tube in the PDP for evacuating the inner space and filling a discharge gas into the inner space. The interior of the tip tube may also be included in the above mentioned inner space of the PDP.

### INDUSTRICAL APPLCABILITY

According to the PDP of the present invention as described above, impurities existing in the inner space of the PDP can be reduced and thereby high picture quality and long life of the PDP can be attained and the PDP can be made effective when applied to display apparatuses of big screen and high picture quality.

1. A plasma display panel comprising:
a front panel and a back panel disposed to oppose each other with an inner space formed therebetween; and
a catalyst reacting with a hydrocarbon provided in an exposed manner to the inner space.

2. The plasma display panel according to claim 1, wherein
the catalyst is contained in a component part of the plasma display panel exposed to the inner space.

3. The plasma display panel according to claim 2, wherein
the component part is constituted of at least one of a protective layer formed on the front panel, a barrier rib formed on the back panel, a phosphor layer formed on the back panel, and a base dielectric layer formed on the back panel.

4. The plasma display panel according to any of claim 1, wherein
the catalyst is a catalyst accelerating oxidization of a hydrocarbon.

5. The plasma display panel according to claim 4, wherein
the catalyst is at least one selected out of Pd, Pt, Rh, Co₃O₄, PdO, Cr₂O₃, Mn₂O₃, Ag₂O, CuO, MnO₂, CoO, and NiO.

6. The plasma display panel according to claim 1, wherein
the catalyst is a catalyst accelerating decomposition of a hydrocarbon.

7. The plasma display panel according to claim 6, wherein
the catalyst is at least one selected out of Co, Mn, Zn, Ti, TiO₂, and Ni.

8. The plasma display panel according to claim 2, wherein
the catalyst is a catalyst accelerating oxidization of a hydrocarbon.

9. The plasma display panel according to claim 3, wherein
the catalyst is a catalyst accelerating oxidization of a hydrocarbon.

10. The plasma display panel according to claim 2, wherein
the catalyst is a catalyst accelerating decomposition of a hydrocarbon.

11. The plasma display panel according to claim 3, wherein
the catalyst is a catalyst accelerating decomposition of a hydrocarbon.
